(19) United States
(12) Patent Application Publication
(10) Pub. No.: US 2013/0012154 A1
(43) Pub. Date: Jan. 10, 2013

(54) ALERT SYSTEM AND METHOD

(75) Inventor: Gerardo Payan Ramos, El Paso, TX (US)

(73) Assignee: Shortcode7 LLC, El Paso, TX (US)

(21) Appl. No.: 13/543,431

(22) Filed: Jul. 6, 2012

Related U.S. Application Data
(60) Provisional application No. 61/505,644, filed on Jul. 8, 2011.

(51) Int. Cl. H04W 4/22; H04W 4/12

(52) U.S. Cl. 455/404.2

(57) ABSTRACT

Embodiments of the disclosure are a computer-implemented emergency and weather alert system. In the emergency alert system, an emergency alert from a user is sent to an individual or a selected group of people, family, or friends, with an additional emergency notice sent to law enforcement agencies. In the weather and/or natural disaster alert system, a user can send and receive weather alerts on a mobile communications device during inclement weather or natural disasters.

### CROSS-REFERENCE TO RELATED APPLICATIONS

This application claims the benefit of U.S. Provisional Application No. 61/505,644, filed Jul. 8, 2011, which is hereby incorporated by reference.

### BACKGROUND OF THE INVENTION

Currently there are few options that are given to people in emergency situations. The main response to most emergency situations is to contact a public emergency service agency, such as the Police or Emergency Medical Services through a number such as 911 in the United States. Many of these public agencies are underfunded, understaffed, and do not have the capacity to respond to a large number of people requesting their services all at once. Even when public agencies are able to respond quickly, people naturally want to make their family and friends aware of their danger. Further, there is no easy way to send a targeted alert to people who need to be made aware of possible upcoming natural disasters or emergency situations.

Natural disasters are those disasters that occur through natural means. These disasters include blizzard, flood, tornado, hurricane, volcanic eruption, earthquake, heat wave, or landslide, for example. Emergency situations cover natural disaster situations and non-naturally occurring situations such as kidnapping, civil unrest, criminal activity and terrorist activity. These situations can occur with little warning and early awareness of danger by emergency responders is critical.

### BRIEF SUMMARY OF THE INVENTION

Embodiments of the disclosure are a computer-implemented emergency and weather alert system. In the emergency alert system, an emergency alert is sent to an individual or a selected group of people, family, or friends, with an additional emergency notice sent to law enforcement agencies. In the weather and/or natural disaster alert system, a user can send and receive weather alerts on a mobile communications device during inclement weather or natural disasters.

A general embodiment of the disclosure is a system comprising: memory; a processor linked to the memory, wherein the processor is configured to: receive a message from a remote user; match the message from the remote user to a user account, wherein the user account comprises contact information for one or more recipients; determine the location of the remote user from the message; send at least one message including a location indicator for the user to the one or more recipient; and send a location indicator for the user to at least one emergency response agency. The processor may be further configured to receive an indication of a type of emergency, such as a blizzard, food, tornado, hurricane, volcanic eruption, earthquake, heat wave, landslide, kidnapping, civil unrest, assault, criminal activity, terrorist activity and/or any combinations thereof. The received message may comprise a telephone number, account number, name, email address, letter, sequence of numbers, sequence of letters, word, picture, or GUI selection, address, GPS location, message routing information, an indication of a type of emergency, a predetermined code, and any combination thereof. In an embodiment of the disclosure, the message is received by the processor from a dedicated application, SMS text, an email, a home alarm system, or a car alarm system and messages may be sent to the recipient through an email, a SMS text, an automated phone call, a dedicated application, or any combination thereof. The sent message may include a pictorially mapped location or a link to a map, and the map at the link may be updated with user location information as new location information becomes available. Additionally messages may be sent to the recipient with updated information including updated user location information. The location of the remote user may be determined by a GPS locator, a triangulated signal, or from message routing information, for example.

Another general embodiment of the invention is a computerized method for an emergency alert system comprising: receiving a message from a remote user; matching the message from the remote user to a user account, wherein the user account comprises contact information for one or more recipients; determining the location of the remote user from the message; sending at least one message including a location indicator for the user to the one or more recipient; and sending a location indicator for the user to at least one emergency response agency. The method may further comprise receiving an indication of a type of emergency, such as a blizzard, food, tornado, hurricane, volcanic eruption, earthquake, heat wave, landslide, kidnapping, civil unrest, assault, criminal activity, terrorist activity and/or any combinations thereof. The received message may comprise a telephone number, account number, name, email address, letter, sequence of numbers, sequence of letters, word, picture, or GUI selection, address, GPS location, message routing information, an indication of a type of emergency, a predetermined code, and any combination thereof. In an embodiment of the disclosure, the message is received by the processor from a dedicated application, SMS text, an email, a home alarm system, or a car alarm system and messages may be sent to the recipient through an email, a SMS text, an automated phone call, a dedicated application, or any combination thereof. The sent message may include a pictorially mapped location or a link to a map, and the map at the link may be updated with user location information as new location information becomes available. Additionally messages may be sent to the recipient with updated information including updated user location information. The location of the remote user may be determined by a GPS locator, a triangulated signal, or from message routing information, for example.

A non-transitory computer readable storage medium with an executable program stored thereon, wherein the program instructs a microprocessor to perform steps comprising: loading into memory a message from a remote user; matching the message from the remote user to a user account, wherein the user account comprises contact information for one or more recipients; determining the location of the remote user from the message; sending at least one message including a location indicator for the user to the one or more recipient; and sending a location indicator for the user to at least one emergency response agency. The method may further comprise receiving an indication of a type of emergency, such as a blizzard, food, tornado, hurricane, volcanic eruption, earthquake, heat wave, landslide, kidnapping, civil unrest, assault, criminal activity, terrorist activity and/or any combinations thereof. The received message may comprise a telephone number, account number, name, email address, letter, sequence of numbers, sequence of letters, word, picture, or GUI selection, address, GPS location, message routing information, an indication of a type of emergency, a predetermined code, and any combination thereof. In an embodiment of the disclosure, the message is received by the processor from a dedicated application, SMS text, an email, a home alarm system, or a car alarm system and messages may be sent to the recipient through an email, a SMS text, an automated phone call, a dedicated application, or any combination thereof. The sent message may include a pictorially mapped location or a link to a map, and the map at the link may be updated with user location information as new location information becomes available. Additionally messages may be sent to the recipient with updated information including updated user location information. The location of the remote user may be determined by a GPS locator, a triangulated signal, or from message routing information, for example.

A general embodiment of the disclosure is a system comprising: memory; a processor linked to the memory, the processor configured to: determine at least one user location; determine a location of an emergency condition based on at least one predetermined parameter; in response to the determination of the user location and the determination of the emergency condition location, send at least one emergency situation message to the user. In an embodiment of the invention, the emergency situation message is sent to the user when the user, or one of the user's selected recipients, is located in or near the emergency condition location. The emergency condition may be a blizzard, flood, hurricane, typhoon, tsunami, and/or seismic event, for example. The predetermined parameter may be based at least in part on historical data or normalized data related to an emergency condition. The emergency condition location is may be determined at least in part on data received from weather sensors, seismic sensors, or any combination thereof.

Another general embodiment of the disclosure is a computerized method for an emergency alert system comprising: receiving a message from a remote user; determining at least one user location; determining a location of an emergency condition based on at least one predetermined parameter; in response to the determination of the user location and the determination of the emergency condition location, sending at least one emergency situation message to the user. In an embodiment of the invention, the emergency situation message is sent to the user when the user, or one of the user's selected recipients, is located in or near the emergency condition location. The emergency condition may be a blizzard, flood, hurricane, typhoon, tsunami, and/or seismic event, for example. The predetermined parameter may be based at least in part on historical data or normalized data related to an emergency condition. The emergency condition location is may be determined at least in part on data received from weather sensors, seismic sensors, or any combination thereof.

A general embodiment of the invention is a non-transitory computer readable storage medium with an executable program stored thereon, wherein the program instructs a microprocessor to perform steps comprising: determining at least one user location; determining a location of an emergency condition based on at least one predetermined parameter; in response to the determination of the user location and the determination of the emergency condition location, sending at least one emergency situation message to the user. In an embodiment of the invention, the emergency situation message is sent to the user when the user, or one of the user's selected recipients, is located in or near the emergency condition location. The emergency condition may be a blizzard, flood, hurricane, typhoon, tsunami, and/or seismic event, for example. The predetermined parameter may be based at least in part on historical data or normalized data related to an emergency condition. The emergency condition location is may be determined at least in part on data received from weather sensors, seismic sensors, or any combination thereof.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is an illustration of the parts and data flow of an embodiment of the invention; and

FIG. 2 is an illustration of the parts and data flow of a second embodiment of the invention.

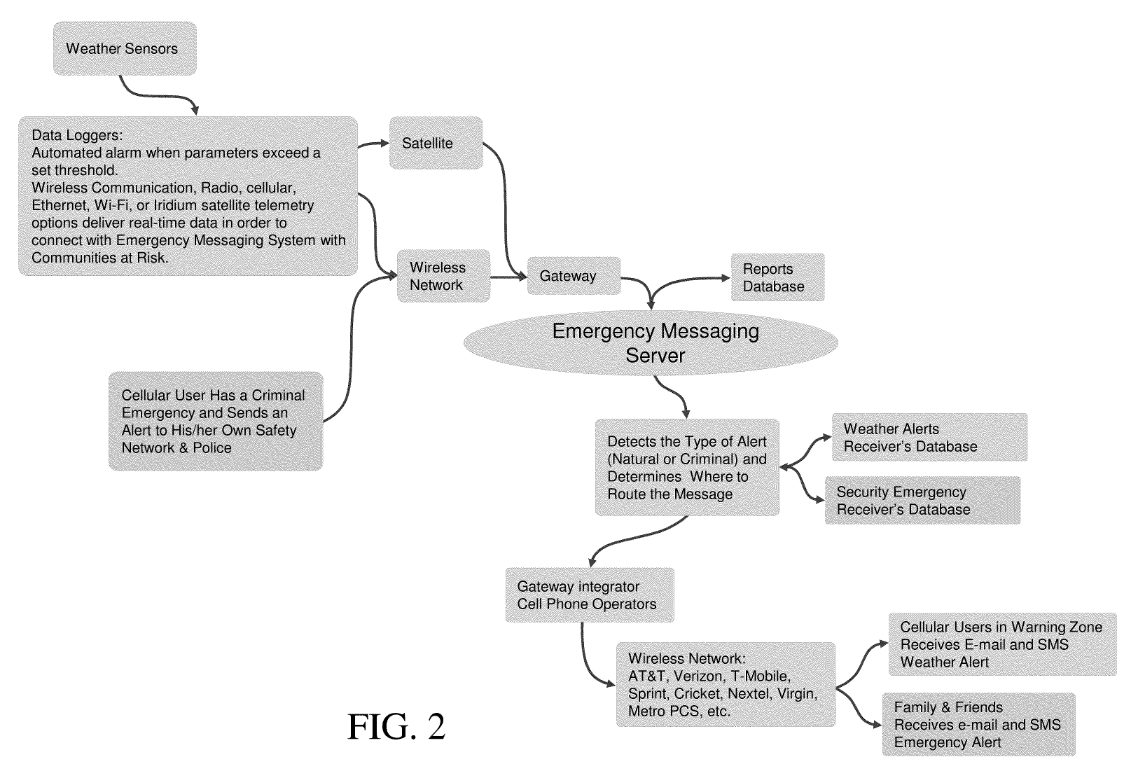

### DETAILED DESCRIPTION OF THE INVENTION

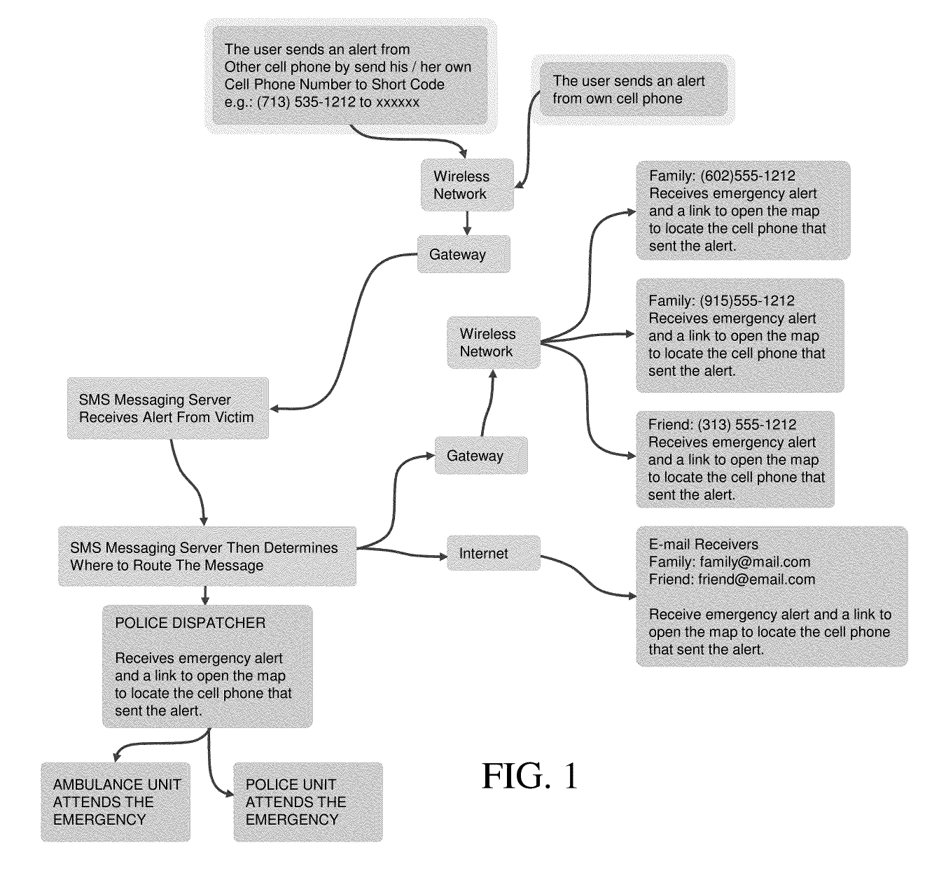

In one embodiment of the present disclosure, when a user is in an emergency situation such as an assault, kidnapping, severe weather event, or natural disaster etc., the user can send an emergency alert from a mobile communications device, such as a cellular phone, smart phone, or tablet device, by constantly pressing a key, a number, a sequence of numbers, or selections in an interactive graphical user interface (GUI). In addition to receiving an emergency alert via text message, email, Tweet, dedicated application, push, or any other communication method, the selected alert group or individual receives a location indication, such as a pictorial mapped location or a link to a mapped location on a website, or GPS coordinates, for example, of the user sending the emergency alert to help locate the user sending the alert. The system determines the location of the user sending the alert from a GPS locator, a triangulation device within the user's mobile communications device, a home or car alarm system, or from the routing information from the sent alert message. If the user were to lose his own phone, the user can also send an emergency alert from the cell phone of another person by sending the user's own cell phone number to a short code text message number, for example. A mobile device can be pre-configured to send an emergency alert. Pre-configuration can include downloading a dedicated application in a cell phone unit. A dedicated application refers to an application or program that is loaded on the user's device, and is dedicated to communicating with the emergency messaging system. Embodiments of the emergency system can be integrated into car alarms, house alarms, and home and office computer systems. Specific embodiments of the invention are illustrated in FIG. 1, and can function as follows, but are not limited to the specific sequence or exemplary steps.

First, a user creates an account on the emergency system, such as through a sign-up or sign-up procedure, for example by going to a webpage and entering in new user account information. Additionally, a user may be able to create an account through a dedicated smartphone or tablet application, for example. In embodiments of the present disclosure, the user enters in their contact information, such as their full name, home address, home alarm system information, car alarm system information, cell phone number, mobile device identification number, picture, fingerprints, and email, for example. Billing information, such as credit card numbers can also be entered. An emergency messaging server of embodiments of the invention receives the user's information and stores the user's information in a database, for example.

The user then adds a group or multiple groups of alert recipients by entering in contact information or by sending an invitation to each group member through SMS text messages or email. Individual recipients may be added to different groups, such as friends, family, work, for example. If acceptance of an invitation is needed, when the recipient accepts the invitation to be a member of an alert group, the system adds the recipient to the contact group and may send a link to the recipient to download the emergency messaging application on the recipient's cell phone. It is noted that a recipient with the dedicated application may only display the location of a cell phone if the cell phone in question has generated an emergency alert that the recipient has received. The user may also add contacts for additional private security firms that the user has an account with. The user's recipient contact information is received by the emergency messaging server and is stored in a database. The user can also download information from the emergency messaging server, such as a mobile application.

When faced with an emergency situation, the user can enter an alert message that is sent to the emergency messaging server. If using a mobile phone, such as a smartphone, the user may enter the alert through a dedicated application. The dedicated application may also request additional information from the user, such as type of emergency or so forth. The user can enter the alert through a variety of means, such as a predetermined code. The predetermined code can include a series of numbers or letters, words, or so forth, or a type of swipe on a touch based device, such as a figure eight design, or a series of swipes. The user may have multiple predetermined codes that may be used to signify different types of emergency situations, for example a text with a message of 1234 from a phone number of 713-555-1212 may indicate that the user with the phone number 713-555-1212 is in a natural disaster, and a text with a message of 4321 from a phone number of 713-555-1212 may indicate that the user has been kidnapped. Additionally, if the user does not have his own mobile phone with him, he can use a different device to send a message to the emergency server through a shortcode text to a dedicated SMS number that is associated with the emergency messaging server or through an email to the emergency messaging server, for example. The user can also send a shortcode alert from his own phone. Any message sent to the emergency messaging server may include user identification, such as name and/or cell phone number; type of emergency; and/or a predetermined code. In embodiments of the invention, the user is also able to send a picture, such as a picture taken with a mobile device while in the emergency situation or a picture of the user to the emergency messaging server, through an email or MMS message, for example.

When the user sends an emergency alert during an emergency situation, the emergency messaging server receives the user's information, such as cell phone number, name, emergency type and/or a location indicator for the user's last known position. The emergency messaging server then forwards relevant information, such as the user's name, phone number, emergency type and/or location indicator, to a recipient or recipient alert group that is associated with the user's account. The location indicator may include a GPS location or a link to a map which has an indication of the recipients last known position. Additional messages with updated location information can continue to be sent to the recipients by tracking the location of the device the alert was sent from. Additionally, the linked map may be updated and the user's location tracked on a map. The message may be sent to the recipients through a dedicated application, SMS text, automated phone message, or email, for example. All of the information sent from the user and received by the emergency messaging server is also sent to public law enforcement agencies (police departments) and/or private security agencies to alert the police or security advisors to proceed immediately to the location of the mobile communications device that sent the warning. Additionally, if a recipient is also a user of the emergency messaging system, the recipient may send additional alerts out through the emergency messaging system to his recipient contact network and start an emergency chain.

Various features and advantageous details are explained more fully with reference to the nonlimiting embodiments that are illustrated in the accompanying drawings and detailed in the following description. Descriptions of well known components and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well- known structures, materials, or operations are not shown or described in detail to avoid obscuring aspects of the invention.

In one embodiment, the user device is referred to broadly and is intended to encompass any suitable device such as a desktop computer, a laptop computer, a Personal Digital Assistant (PDA), a mobile communication device or organizer device, a home alarm, and a car alarm, for example. In a further embodiment, the user device may access the Internet to access a web application or web service hosted by an emergency messaging server and provide a user interface for enabling the user to enter user profile information and/or service provider criterion, as described above.

A network may facilitate communications of data between the server and the user's device. The network may include any type of communications network including, but not limited to a direct PC to PC connection, a local area network (LAN), a wide area network (WAN), a modem to modem connection, the internet, a wireless mobile connection such as WIFI or cell, NFC, Bluetooth, a combination of the above, or any other communications network now known or later developed within the networking arts which permits two or more devices to communicate with each other.

In one embodiment, a server is configured to collect user profile information and recipient contact information. Specifically, the server may receive the information from an application user interface accessed over the network by the user's device. Additionally, the server is configured to receive alert messages from one or more user's, to match the user's information with a user account, and to send out emergency data including the user's information to public emergency response, to private security companies and/or to the recipients identified by the user. Additionally, the server may access data stored in a data storage device, such as a database server via a Storage Area Network (SAN) connection, a LAN, a data bus, or the like.

The data storage device may include a hard disk, including hard disks arranged in an Redundant Array of Independent Disks (RAID) array, a tape storage drive comprising a plurality of magnetic tape data storage devices, or the like. In one embodiment, the data storage device stores user account information, recipient contact information and predetermined codes related to the account. The service records may be arranged in a database and accessible through Structured Query Language (SQL) queries, or other database query operations.

The server and the user device may be implemented on known computer systems, which is briefly described below. It is also understood that the server may be a stand-alone server, or a series of interconnected servers. The computer system may include a central processing unit (CPU) coupled to a system bus. The CPU may be any general purpose CPU, or special purpose CPU. The present embodiments are not restricted by the architecture of the CPU as long as the CPU supports an embodiment of the invention as described herein. The CPU may execute various logical instructions according to embodiments of the present invention. For example, the CPU may match a received alert to a user account. The computer system also may include Random Access Memory (RAM), which may be SRAM, DRAM, SDRAM, or the like. The computer system may utilize RAM to store the various data structures used by a software application configured to operate as an emergency messaging alert system. The computer system may also include Read Only Memory (ROM) which may be PROM, EPROM, EEPROM, or the like. The ROM may store configuration information for booting the server. The RAM and the ROM may hold user and system data.

The computer system may also include an input/output (I/O) adapter, a communications adapter, a user interface adapter, and a display adapter. The I/O adapter and/or the user interface adapter may, in certain embodiments, enable a user to interact with the computer system in order to input information for user profile information and alert information. In a further embodiment, a display adapter may display a graphical user interface associated with a software or web-based application.

The I/O adapter may connect to one or more storage devices, such as one or more of a hard drive, a Compact Disk (CD) drive, a floppy disk drive, a tape drive, to the computer system. The communications adapter may be adapted to couple the computer system to the network 106, which may be one or more of a LAN and/or WAN, and/or the Internet. The user interface adapter couples user input devices, such as a keyboard and a pointing device, to the computer system. The display adapter may be driven by the CPU to control the display on the display device.

The present embodiments are not limited to a specific architecture, rather the computer system is offered as an example of one type of computing device that may be adapted to perform the functions of either the server or the user interface device. For example, any suitable device may be utilized including without limitation cell phones, home alarm systems, car alarm systems, personal data assistants (PDAs), computer game consoles, and multi-processor servers. Moreover, embodiments of the present invention may be implemented on application specific integrated circuits (ASIC) or very large scale integrated (VLSI) circuits.

The following are examples provided to illustrate the concepts included herein. It is understood that this example is for illustrative purposes only and is not intended as limitations of the disclosed embodiments:

In a specific embodiment of the disclosure, the user sends an alert from his own cell phone by SMS text, such as by texting “ALERT—NATURAL DISASTER” to a shortcode number such as 12345. An emergency messaging server receives the alert from the user, through such means as a gateway and SMS server. The server matches the user to an account. The emergency messaging server then determines which recipients to route the message to, such as Family—713-555-1212, Friend—name@email.com, and Emergency Services—911. A message containing the user's name and a web link to a map is sent to the selected recipients via the appropriate channel such as phone or email. The map at the link may then be updated in real-time to track the location of the user's cell phone.

In a second embodiment of the present disclosure, the disclosed alert system can also be utilized to send and receive weather or natural disaster-related emergency alerts via text message or email. Possible weather events include, for example, tornados, hurricanes, severe storms, etc. Possible natural disasters include, for example, volcanoes, earthquakes, tsunamis, landslides, etc. Users can send/receive information before, during, and after the emergency weather event and/or natural disaster. A selected group, such as family, can be sent an alert to help locate a user trapped during and after one of these events. In addition to receiving an emergency alert via text message, email, Tweet, and any other communication method, the selected alert group or individual may receive a pictorial mapped location, link to a mapped location, or GPS coordinates, of the user sending the emergency alert to help locate the user sending the alert. The following example is provided to illustrate the concepts included herein. It is understood that examples are for illustrative purposes only and is not intended as limitations of the disclosed embodiments.

In the second embodiment, the emergency messaging server receives localized information from monitoring systems, such as video feeds, weather monitoring stations, seismic data, or the like. The server stores the monitoring data and compares historical data, normalized data, or a predetermined threshold with the real-time data. If the difference between the originally stored data and the real-time data exceeds a set threshold, the server triggers an alarm. For example, if the zip code 77010 historically received an average of 3 inches of rain each day in recorded July rain fall data, an alert may be triggered on a day in July when the rain fall exceeds 18 inches. All users from the system who have agreed to have their locations tracked by the messaging system and are located in the zip code 77010 would then receive an alert that heavy rainfall has occurred and to be mind-full of flash flooding.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system comprising:
memory;
a processor linked to the memory, the processor configured to:
receive a message from a remote user;
match the message from the remote user to a user account, wherein the user account comprises contact information for one or more recipients;
determine the location of the remote user from the message;
send at least one message including a location indicator for the user to the one or more recipient; and
send a location indicator for the user to at least one emergency response agency.

2. The system of claim 1, wherein the processor is further configured to receive an indication of a type of emergency.

3. The system of claim 2, wherein the type of emergency is selected from the group consisting of a blizzard, food, tornado, hurricane, volcanic eruption, earthquake, heat wave, landslide, kidnapping, civil unrest, assault, criminal activity, terrorist activity and any combinations thereof.

4. The system of claim 1, wherein the content of the received message is selected from the group consisting of a telephone number, account number, name, email address, letter, sequence of numbers, sequence of letters, word, picture, or GUI selection, address, GPS location, message routing information, an indication of a type of emergency, a predetermined code, and any combination thereof.

5. The system of claim 1, wherein the received message is received by the processor from a dedicated application, SMS text, an email, a home alarm system, a car alarm system, a

6. The system of claim 1, wherein the message is sent to the recipient through an email, a SMS text, an automated phone call, a dedicated application, or any combination thereof.

7. The system of claim 1, wherein the message sent to the recipient additionally comprises a pictorially mapped location or a link to a map.

8. The system of claim 1, wherein the map at the link is updated with user location information.

9. The system of claim 1, wherein additional messages are sent to the one or more recipient with updated user location information.

10. The method of claim 1, wherein the location of the remote user from the message is determined by a GPS locator, a triangulation device, or from routing information.

11. A computerized method for an emergency alert system comprising:
receiving a message from a remote user;
matching the message from the remote user to a user account, wherein the user account comprises contact information for one or more recipients;
determining the location of the remote user from the message;
sending at least one message including a location indicator for the user to the one or more recipient; and
sending a location indicator for the user to at least one emergency response agency.

12. A non-transitory computer readable storage medium with an executable program stored thereon, wherein the program instructs a microprocessor to perform steps comprising:
loading into memory a message from a remote user;
matching the message from the remote user to a user account, wherein the user account comprises contact information for one or more recipients;
determining the location of the remote user from the message;
sending at least one message including a location indicator for the user to the one or more recipient; and
sending a location indicator for the user to at least one emergency response agency.

13. A system comprising:
memory;
a processor linked to the memory, the processor configured to:
determine at least one user location;
determine a location of an emergency condition base on at least one predetermined parameter;
in response to the determination of the user location and the determination of the emergency condition location, send at least one emergency situation message to the user.

14. The system of claim 13, wherein the at least one emergency situation message is sent to the user when the user is located in or near the emergency condition location.

15. The system of claim 13, wherein the emergency condition is a blizzard, flood, hurricane, typhoon, tsunami, seismic event or any combination thereof.

16. The system of claim 13, wherein the predetermined parameter is based at least in part on historical data or normalized data related to an emergency condition.

17. The system of claim 13, wherein the emergency condition location is determined at least in part on data received from weather sensors, seismic sensors, or any combination thereof.

18. A computerized method for an emergency alert system comprising:
receiving a message from a remote user;
determining at least one user location;
determining a location of an emergency condition base on at least one predetermined parameter;
in response to the determination of the user location and the determination of the emergency condition location, sending at least one emergency situation message to the user.

19. A non-transitory computer readable storage medium with an executable program stored thereon, wherein the program instructs a microprocessor to perform steps comprising:
determining at least one user location;
determining a location of an emergency condition base on at least one predetermined parameter;
in response to the determination of the user location and the determination of the emergency condition location, sending at least one emergency situation message to the user.
